(19) United States
(12) Patent Application Publication
(10) Pub. No.: US 2013/0266921 A1
(43) Pub. Date: Oct. 10, 2013

(54) Student Response Replay with Flexible Data Organization and Representation Overlays

(71) Applicants: Robert Charles Wellman Jenks, McKinney, TX (US); Corey Edison Brady, Wilmette, IL (US); Mark Dennis Fry, Dallas, TX (US); Albert Louis Abrahamson, Yorktown, VA (US)

(72) Inventors: Robert Charles Wellman Jenks, McKinney, TX (US); Corey Edison Brady, Wilmette, IL (US); Mark Dennis Fry, Dallas, TX (US); Albert Louis Abrahamson, Yorktown, VA (US)

(21) Appl. No.: 13/439,691

(22) Filed: Apr. 4, 2012

(51) Int. Cl. G09B 5/00

(52) U.S. Cl. 434/350

(57) ABSTRACT

A method for operating a classroom network including a host computer and a plurality of digital devices communicatively coupled to the host computer is provided. The method includes receiving student responses by the host computer from the plurality of digital devices over a period of time, wherein the student responses are generated while performing a class activity on each digital device, storing the student responses as the student responses are received, and replaying a user selected portion of the stored student responses on the host computer, wherein the replayed student responses are displayed according to a first user specified analysis view.

### BACKGROUND OF THE INVENTION

1. Field of the Invention

Embodiments of the present invention generally relate to replay of student responses in a classroom network.

2. Description of the Related Art

With ever increasing frequency, school classrooms are equipped with a classroom learning system in which digital devices, e.g., handheld calculators, for student use are connected to a host computer used by the teacher. Such a classroom learning system allows a teacher to perform actions such as creating and managing lessons, transferring files between the computer and the digital devices, monitoring student activity on the digital devices using screen captures, polling, assessments, etc., and performing various interactive activities with the students. Various tools are also provided for creating, distributing, and analyzing educational content. The TI-Nspire™ Navigator™ System from Texas Instruments, Inc. is an example of such a classroom learning system.

In a networked classroom, student responses may be collected from handheld calculators for the duration of an activity and aggregated in a way that makes sense for the pedagogical value of the activity acted out in real-time. However, an important piece of learning is reflecting on the process it took to get there, or evaluating the activity after it has been acted out in real time. To improve the learning experience, it is important for teachers and students to verbalize and share decisions made during the activity and understand the ramifications of those decisions mathematically.

### SUMMARY

Embodiments of the present invention relate to methods and systems for replay of student responses in a classroom network. In one aspect, a method for operating a classroom network that includes a host computer and a plurality of digital devices communicatively coupled to the host computer is provided. The method includes receiving student responses by the host computer from the plurality of digital devices over a period of time, wherein the student responses are generated while performing a class activity on each digital device, storing the student responses as the student responses are received, and replaying a user selected portion of the stored student responses on the host computer, wherein the replayed student responses are displayed according to a first user specified analysis view.

In one aspect, a classroom network is provided that includes a plurality of digital devices and a host computer communicatively coupled to the plurality of digital devices and configured to receive student responses from the plurality of digital devices over a period of time, wherein the student responses are generated while performing a class activity on each digital device, store the student responses as the student responses are received, and replay a user selected portion of the stored student responses, wherein the replayed student responses are displayed according to a first user specified analysis view.

### BRIEF DESCRIPTION OF THE DRAWINGS

Particular embodiments in accordance with the invention will now be described, by way of example, and with reference to the accompanying drawings:

FIGS. 1A and 1B show examples of classroom networks;

FIG. 2 shows an example of a handheld calculator;

FIG. 3A is a block diagram of a handheld calculator;

FIG. 3B is a block diagram of a computer system;

FIG. 4 is a block diagram of a classroom network architecture;

FIG. 5 is a flow diagram of a method for student response replay; and

FIGS. 6A-6R show an example of using student response replay.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

In other settings than the classroom, e.g., athletics, recording activity and replaying it for reflective purposes is nothing new. In classroom activities, however, this is not a common practice. Partly, this can be explained by the fact that there are not many subject-area-specific whole-class technologies—technologies for which the actions of the students in the classroom are truly meaningful discipline-specific activity. In the networked classroom context, collective activity by students can be mathematically meaningful, and the analogy with replay in athletics is apt. Both teachers and students may gain important insights from such replay, and the artifacts of past activities can be powerful teaching tools for the teacher-as-“coach”.

Recording an activity and replaying the activity to discuss with the class is nothing new, particularly with the prolific offering of digital recording devices, and mass marketed video editing tools providing the controls to replay, slow down, pause, etc. However, the information from such video replay may not be dissected in a data rich way. Think of a CSI crew going to analyze a crash scene. They would not stop with a video from one perspective. Such video can be misleading because there is information that cannot be seen from the perspective of the camera. Instead, the CSI crew would obtain additional measurements, other videos with other camera perspectives, and obtain ways to approach the same activity in multiple ways. If the problem can be analyzed at a much deeper, richer level, it is the duty of the investigator to do that. It is the duty of the teacher to provide deep understanding of the process of mathematics and provide environments which help students create meaning for themselves.

Embodiments of the invention provide for replaying student responses during a class activity in a way that provides a data-rich experience with different data representations and perspectives, i.e., different analysis views. That is, student responses from digital devices used by the students during class activities are recorded and time stamped as they are collected by a host computer in the classroom network. The teacher may configure the classroom learning system to display the student responses in one or more analysis views as the student responses are collected during a class activity. The teacher may also replay the collected and time stamped student responses, displaying the student responses in one or more analysis views. In other words, a time-based replay of the collected student responses is provided that allows the student responses to be displayed using different analysis views for additional analysis and learning.

For example, the classroom network can collect point data from digital devices used by the students during an activity. This response data can be displayed in list form, plotted form, or both. In addition, this response data can be displayed as a whole class aggregate view and/or by individual. Further, analysis tools can be layered on top of the different representations such as a regression function on each individual or whole class aggregate. Further, the collected point data can be replayed using different display forms and/or analysis tools. The various combinations of display forms and analysis tools provide analysis views of the response data.

Assume a classroom activity in which ten groups of students are each assigned to a task, each group having a different parameter. As the initial run of the activity unfolds, the whole class aggregate responses are plotted and displayed to the class. An interesting phenomenon happens in which although the ten groups have different parameters, a pattern is emerging in the group space. When the activity is finished, the teacher and the students want to reflect. The teacher can step through time in the collected student responses using similar controls to those for controlling a video. The representations and analysis tools applied to the replayed student responses may include, for example, zooming in and out on a representation while it is paused, moving, etc., changing the representation, comparing different representations, comparing or focusing in on smaller or larger sets of the student responses, layering analysis tools on top of the representations, etc. The analysis tools can include things as simple as annotation or as complex as dependent elements adjusting as data changes such as a regression equation, creating a polygon out of selected points, etc.

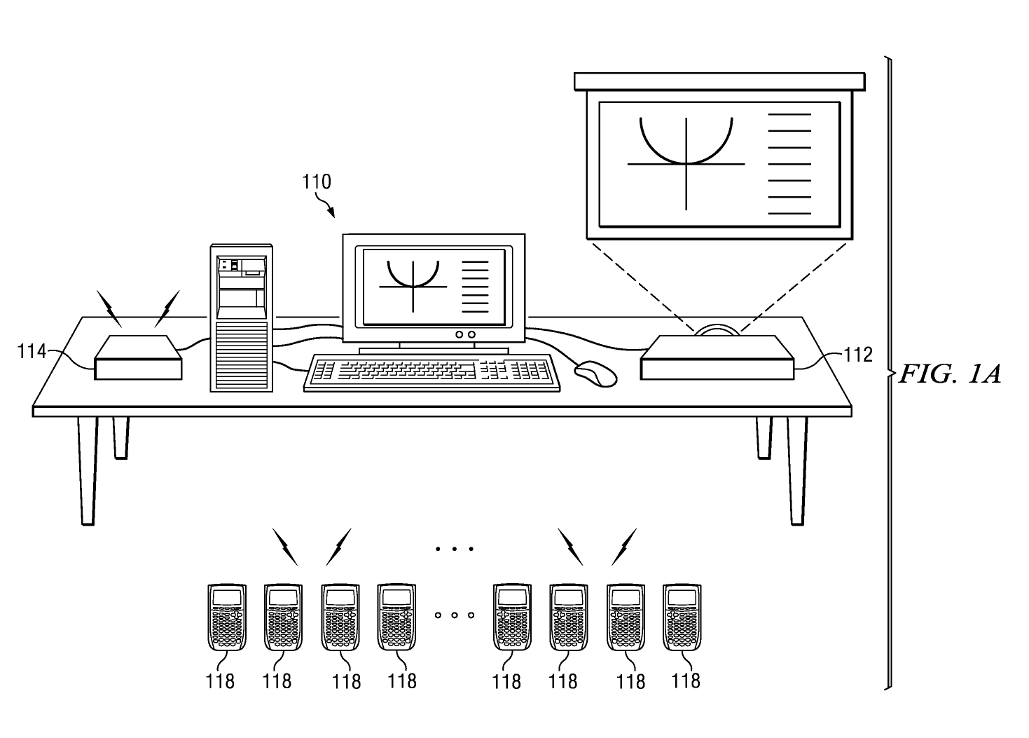

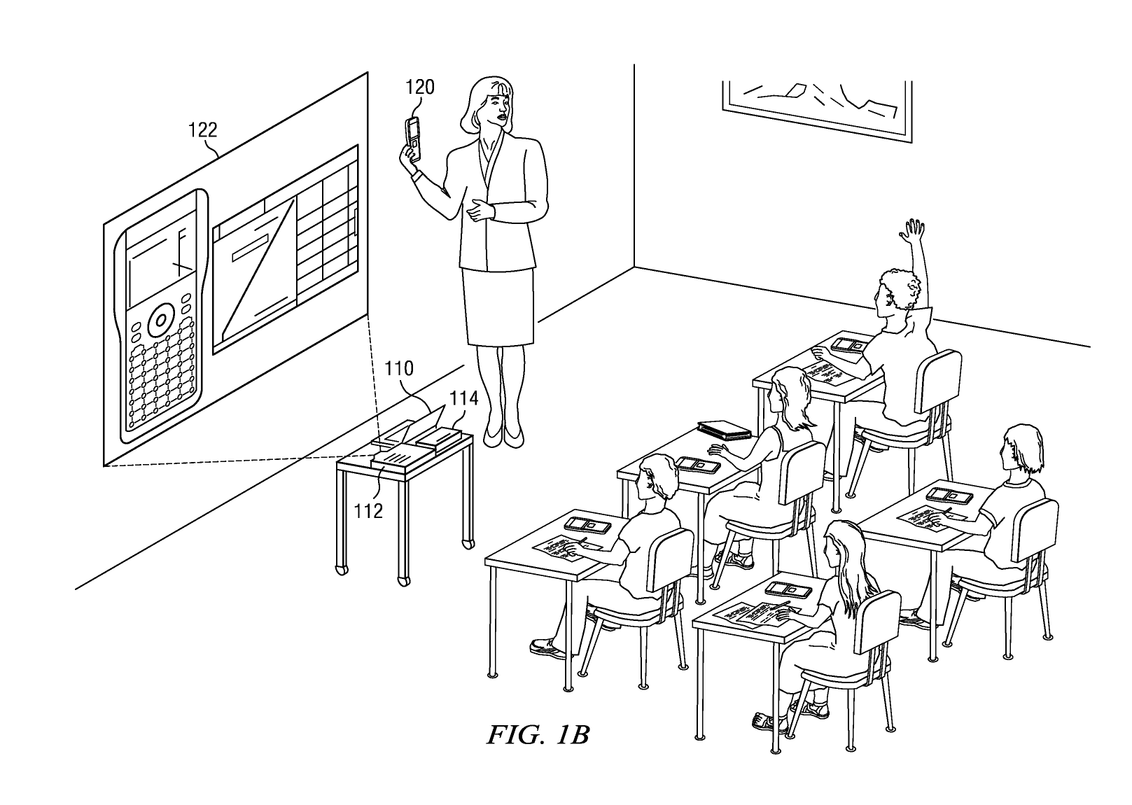

FIG. 1A shows a diagram of a classroom network configured to perform student response replay as described herein. As shown in FIG. 1A, the classroom network includes a computer system 110 communicatively coupled to a projector 112 (e.g., a digital projector), which may project images and video provided by the computer system 110 onto a wall, screen, or other surface. The computer system 110 includes presentation software (not shown) for managing the presentation of screen content received from a handheld calculator as the handheld calculator is operated. The presentation may be made using a display device in the computer system 110, or using a combination of the display device and the projector 112. The computer system 110 may be any general purpose computing device, such as a desktop computer, a mini-computer, a main frame, a laptop computer, a netbook, a tablet computer, or the like.

The computer system 110 is also communicatively coupled to an access point 114 via a Universal Serial Bus (USB) connection. The access point 114 provides a wireless interface such as 802.11b, 802.11g, or the like for the computer system 110 to communicate with one or more handheld calculators 118. Once connected, bi-directional communications may be performed between the handheld calculators 118 and the computer system 110 via the access point 114. The computer system 110 and the access point 114 are illustrated as separate components for illustrative purposes only. In some embodiments, the access point 114 may be integrated into the computer system 110. Further, the coupling between the access point 114 and the computer system 110 may be any suitable wired or wireless connection. The combination of the computer system 110 and the access point 114 are the network host for the classroom network.

The handheld calculators 118 may be any suitable handheld calculators, such as, for example, graphing calculators in the TI-Nspire product line available from Texas Instruments, Inc. To allow wireless communication with the access point 114 and/or the computer system 110, a wireless transceiver may be integrated into a handheld calculator 118 or a wireless adaptor or a wireless cradle may be externally attached via a port on a handheld calculator 118.

FIG. 1B shows an example of a classroom network in a classroom setting. In this embodiment, the computer system 110 is a laptop computer, and the access point 114 is connected by a USB connection to the computer system 110. The instructor's handheld calculator 120 and the handheld calculators in use by the students are all connected by a wireless communication link to the access point 114. Presentation software executing on the computer system 110 is showing the content, i.e., screen image, of the display on the instructor's handheld calculator 120 on the display device of the computer system 110 and on the screen 122 via the projector 112 along with a “skin” duplicating the appearance of the instructor's handheld calculator 120. The projector 112 is used to project the information shown on the display device onto the screen 122.

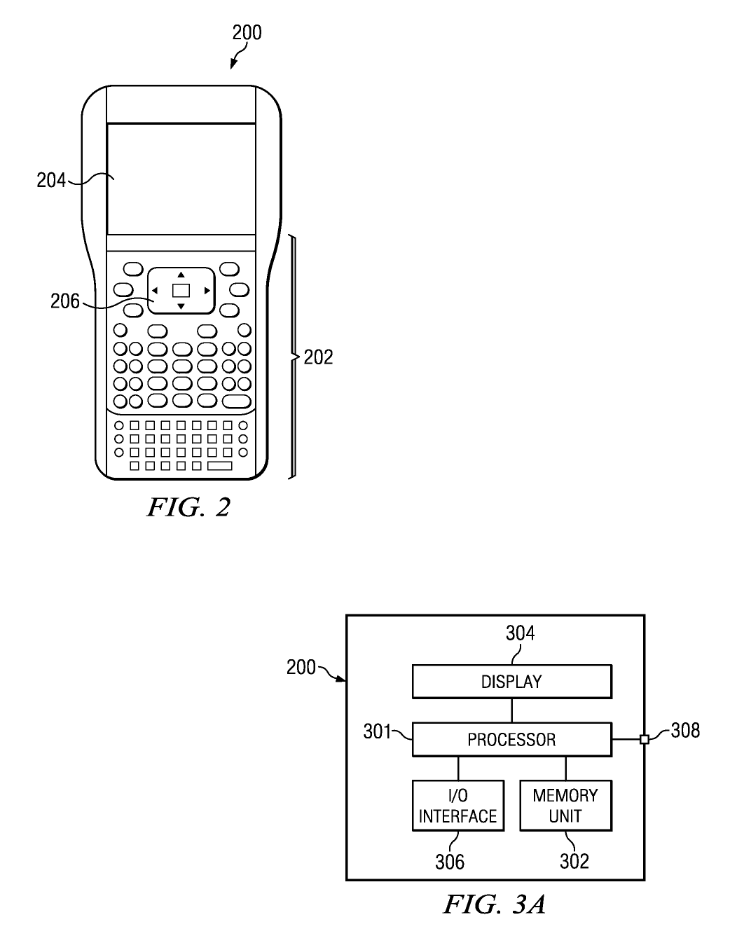

FIG. 2 shows an example of a handheld calculator 200 (e.g., 118, 120 of FIGS. 1A and 1B) in accordance with one or more embodiments. For illustrative purposes, the handheld calculator illustrated in FIG. 2 is similar to graphing calculators available from Texas Instruments Inc. Handheld calculators with more or fewer components may be used in embodiments. As shown in FIG. 2, the handheld calculator 200 includes a graphical display 204, and a keypad 202 that includes a touchpad 206. The graphical display 204 may be used to display, among other things, information input to applications executing on the handheld calculator 200 and various outputs of the applications. The graphical display 204 may be, for example, an LCD display. The keypad 202 allows a user, e.g., a student or instructor, to enter data and functions and to start and interact with applications executing on the handheld calculator 200. The keypad 202 also includes an alphabetic keyboard for entering text. The touchpad 206 allows a user to interact with the display 204 by translating the motion and position of the user's fingers on the touchpad 206 to provide functionality similar to using an external pointing device, e.g., a mouse. A user may use the touchpad 206 to perform operations similar to using a pointing device on a computer system, e.g., scrolling the display 204 content, pointer positioning, selecting, highlighting, etc.

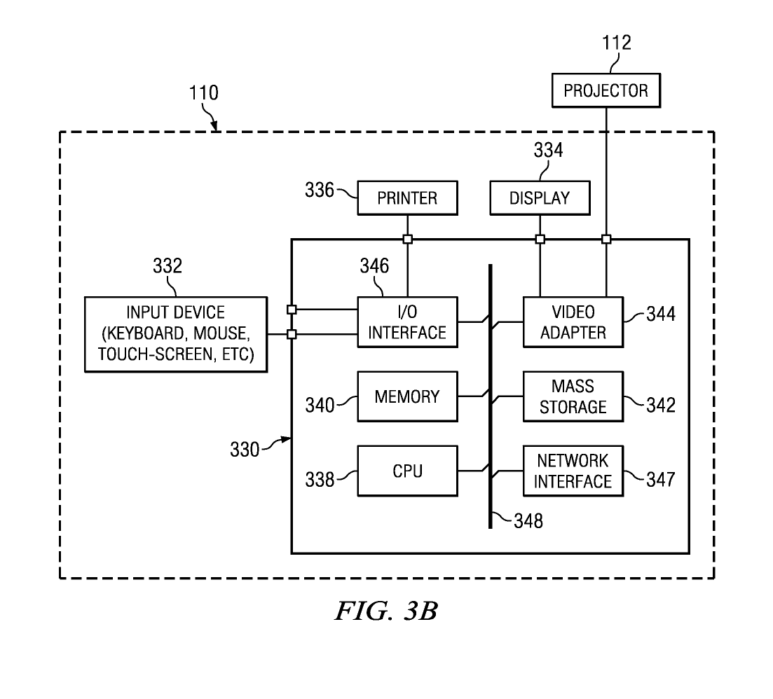

FIGS. 3A and 3B are block diagrams of the handheld calculator 200 and the computer system 110, respectively, in accordance with one or more embodiments. The handheld calculator 200 includes a processor 301 coupled to a memory unit 302, which may include one or both of memory for program storage, e.g., read-only memory (ROM), and memory for non-persistent data and program storage, e.g., random-access memory (RAM). In some embodiments, the program storage memory stores software programs and the memory for non-persistent stores intermediate data and operating results. An input/output port 308 provides connectivity to external devices, e.g., a wireless adaptor or wireless cradle. In one or more embodiments, the input/output port 308 is a bi-directional connection such as a mini-A USB port. Also included in the handheld calculator 200 are a display 304 and an I/O interface 306. The I/O interface 306 provides an interface to couple input devices such as the touchpad 206 and the keypad 202 to the processor 301. In some embodiments, the handheld calculator 200 may also include an integrated wireless interface (not shown) or a port for connecting an external wireless interface (not shown). In one or more embodiments, the memory unit 302 stores software instructions to be executed by the processor 301 to implement some or all of the calculator based operations for class activities and communication with the computer system 110 as described herein.

The computer system 110 includes a processing unit 330 equipped with one or more input devices 332 (e.g., a mouse, a keyboard, or the like), and one or more output devices, such as a display 334, a printer 336, or the like. In some embodiments, the display 334 may be touch screen, thus allowing the display 334 to also function as an input device. The processing unit 330 may be, for example, a desktop computer, a workstation, a laptop computer, a dedicated unit customized for a particular application, or the like. The display may be any suitable visual display unit such as, for example, a computer monitor, an LED, LCD, or plasma display, a television, a high definition television, an interactive white board, or a combination thereof.

The processing unit 330 includes a central processing unit (CPU) 338, memory 340, a mass storage device 342, a video adapter 344, and an I/O interface 346 connected to a bus 348. The bus 348 may be one or more of any type of several bus architectures including a memory bus or memory controller, a peripheral bus, video bus, or the like. The CPU 338 may be any type of electronic data processor. For example, the CPU 338 may be a processor from Intel Corp., a processor from Advanced Micro Devices, Inc., a Reduced Instruction Set Computer (RISC), an Application-Specific Integrated Circuit (ASIC), or the like. The memory 340 may be any type of system memory such as static random access memory (SRAM), dynamic random access memory (DRAM), synchronous DRAM (SDRAM), read-only memory (ROM), a combination thereof, or the like. Further, the memory 340 may include ROM for use at boot-up, and DRAM for data storage for use while executing programs.

The mass storage device 342 (e.g., a computer readable medium) may include any type of storage device configured to store data, programs, and other information and to make the data, programs, and other information accessible via the bus 348. In one or more embodiments, the mass storage device 342 stores software instructions to be executed by the CPU 338 to implement the student response replay techniques described herein. The mass storage device 342 may be, for example, one or more of a hard disk drive, a magnetic disk drive, an optical disk drive, or the like. The software instructions may be initially stored in a computer-readable medium such as a compact disc (CD), a diskette, a tape, a file, memory, or any other computer readable storage device and loaded and executed by the CPU 338. In some cases, the software may also be sold in a computer program product, which includes the computer-readable medium and packaging materials for the computer-readable medium. In some cases, the software may be distributed to the computer system 110 via removable computer readable media (e.g., floppy disk, optical disk, flash memory, USB key), via a transmission path from computer readable media on another computer system (e.g., a server), etc.

The video adapter 344 and the I/O interface 346 provide interfaces to couple external input and output devices to the processing unit 330. As illustrated in FIG. 3B, examples of input and output devices include the display 334 and projector 112 coupled to the video adapter 344 and the mouse/keyboard 332 and the printer 336 coupled to the I/O interface 346.

The processing unit 330 also includes a network interface 347. The network interface 347 allows the processing unit 330 to communicate with remote units via a network (not shown). In one or more embodiments, the network interface 347 allows the computer system 110 to communicate via a network to the handheld calculators 118, 120. The network interface 347 may provide an interface for a wired link, such as an Ethernet cable or the like, or a wireless link.

The computer system 110 may also include other components not specifically shown. For example, the computer system 110 may include power supplies, cables, a motherboard, removable storage media, cases, and the like.

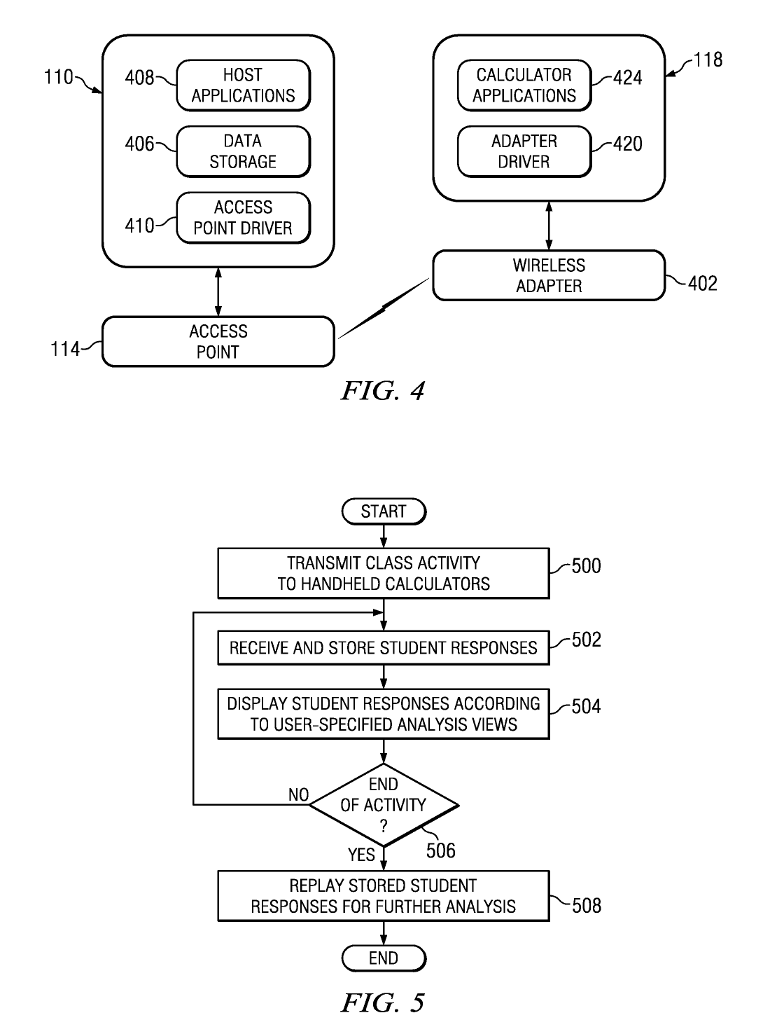

FIG. 4 is a simplified block diagram of the classroom network architecture of FIGS. 1A and 1B. The architecture includes the network host system, i.e., the computer 110 and the access point 114, and a representative calculator 118 coupled to the network via a wireless adaptor 402. The computer 110 includes an access point driver 410, data storage 406, and host applications 408. Other functionality may also be present. The access point driver 410 provides functionality for bidirectional communication with the access point 114. Such communication may include control commands and other information from the host applications 408 to be sent to the calculator 118 and the receipt of responses to the commands and other information from the calculator 118.

The host applications 408 provide classroom management functionality as well as capabilities to create documents such as documents defining class activities, transfer them to connected calculators, collect documents and other data, e.g., student responses, from the calculators, and to automatically collect and grade student work from the calculators and to save and record the student work. The host applications 408 also include features that allow the teacher to create and manage a classroom roster and a student portfolio. The host applications 408 also allow the teacher to view all of the connected calculators and monitor student progress and to display student responses in one or more analysis views as the student responses are collected. The functionality described above may be in one application or spread across multiple applications. Examples of host applications that may be present in an embodiment are described in “TI-nspire™ Navigator™ Teacher Software Guidebook”, Texas Instruments Incorporated, 2011, which is incorporated by reference herein. The host applications 408 also include functionality to perform a method for student response replay as described herein.

The data storage 406 stores data generated and used by the host applications 408. For example, the data storage 406 may store documents, student work collected from the calculators, the classroom roster, student portfolios, etc. The student work collected from the calculators includes student responses to class activities as described herein.

The access point 114 provides routing functionality between the access point 114 and the calculator 118 and functionality to manage the connection activity between the network host and the calculators, e.g., calculator 118. Other functionality may also be present.

The wireless adaptor 402 provides routing functionality between the calculator 118 and the access point 114. The wireless adaptor 402 may also include other functionality.

The representative calculator 118 includes an adaptor driver 420 and calculator applications 424. The calculator applications 424 provide the primary functionality of the calculator. The application functionality includes but is not limited to basic calculations, function graphing, geometry, and statistical analysis. The calculator applications 424 also provide functionality to receive a class activity from the host computer 110, to receive student responses as the class activity is performed, and to communicate the student responses to the host computer. Examples of calculator applications that may be present in an embodiment are described in “TI-nspire™ Student Software Guidebook”, Texas Instruments Incorporated, 2006-2011, which is incorporated by reference herein.

The adapter driver 420 provides functionality for bidirectional communication with the wireless adapter 402. Such communication may include receipt of control commands and other information from the host applications 408 and the transmission of responses to the commands and other information from the calculator applications 424 to host applications 408.

FIG. 5 is a flow diagram of a method for student response replay that may be performed in the classroom network. Initially, a class activity is transmitted 500 from the host computer 110 in the classroom network to the handheld calculators 118. The transmission of the class activity is initiated by the teacher using a user interface on the host computer 110. The class activity may be, for example, one or more questions for student response. The type of a question may be, for example, a multiple choice question, a true/false question, a yes/no question, an agree/disagree question, or the like. A question type may also be, for example, an equation such as y=or f(x)=to which the students supply an answer. A question type may also be, for example, a coordinate points question type that asks for (x,y) coordinate responses or a drop points question type that asks for responses in the form of points placed on a graph. Examples of some question types that may be used in an embodiment and an example interface for generating the question(s) for a class activity may be found in the previously referenced TI-nspire™ Navigator™ Teacher Software Guidebook.

Student responses to the class activity are then received and stored 502 on the host computer 110. More specifically, as the students perform the class activity on the handheld calculators, the responses entered by each student are transmitted from the calculator used by the student to the host computer 110 and then stored in association with the time of receipt in the data storage 406. A student may change a response and the updated response is also received and stored, thus creating a time stamped history of student responses to the class activity. In an embodiment, the teacher initiates a poll on the host computer 110 to retrieve the responses. The host computer 110 then polls each calculator in turn for a response, if any. If a response is available, the host computer 110 receives the response, associates the time of receipt with the response, e.g., assigns a time stamp to the response, and stores the response and the associated time of receipt in the data storage 406. The polling continues until the teacher terminates the polling. During the polling, students may change their responses and the updated responses are also stored.

For example, a teacher may transmit a class activity in the form of a poll that is a math problem expressed as a multiple choice question with a, b, c, d answers. The class activity will pop up on the calculator screens for the students to answer. The students can then select and submit answers, i.e., responses that will be transmitted to the host computer when the calculators are polled. The math problem may be posed at the beginning of a lesson and the teacher may expect that the students will not know the answer but asks them to guess. After the initial guesses are received via the polling, the teacher may teach the concept and the students may change their answers as the lesson progresses. A history of the student responses with times of the responses is maintained throughout the lesson until the teacher terminates the poll.

The student responses and associated times of receipt may be stored in the data storage 406 in any suitable way allowing for retrieval of the responses based on the time of receipt. For example, the student responses and associated times of receipt may be stored in a database or a flat file. The data is stored such that each action the student took to solve the problem is recorded in sequence with timestamps. The system should be able to replay the data such that the teacher can watch the student solve the problem as if the teacher was looking over the student's shoulder.

The received student responses may also be displayed 504 on the host computer 110 according to user specified analysis views as the responses are received. For example, the teacher may choose to view the responses as a bar chart, a graph, and/or a table, depending on the question type. The selected view updates as new responses are received. The teacher may also change analysis views as the responses are received and/or change the configuration options of analysis views. Examples of analysis views and configuration options for analysis views that may be used in an embodiment may be found in the previously referenced TI-nspire™ Navigator™ Teacher Software Guidebook.

Continuing the previous example, the teacher may view the student responses in a table format showing the name of each student, the current response of that student, and the time that response was submitted. In this view, the teacher can see which students have submitted answers and which have not. The teacher may also switch to (or concurrently view) another tabular view which shows each of the possible responses, i.e., a, b, c, d, and the frequency of each response.

The receiving and storing of student responses and the displaying of the student responses continues for a period of time until the activity is ended 506 by the teacher. The stored student responses may then be replayed 508 for further analysis. That is, the teacher may “rewind” the student response history to any point during the period of time the responses were received and “replay” the responses from the selected point forward in the order the responses were received, displaying the replayed responses according to one or more of the analysis views. Just as when the responses were received live, the analysis views will update as each replayed response is processed. The teacher may also stop the replay of the responses at any time and resume the replay. The teacher may change the representation and/or analysis tool in an analysis view while the responses are actively replaying. The teacher may also display multiple analysis views on the screen to view different perspectives. In this way, the teacher may analyze the student responses using different representations and/or different configurations of the representations and/or different analysis tools than were used as the responses were initially collected.

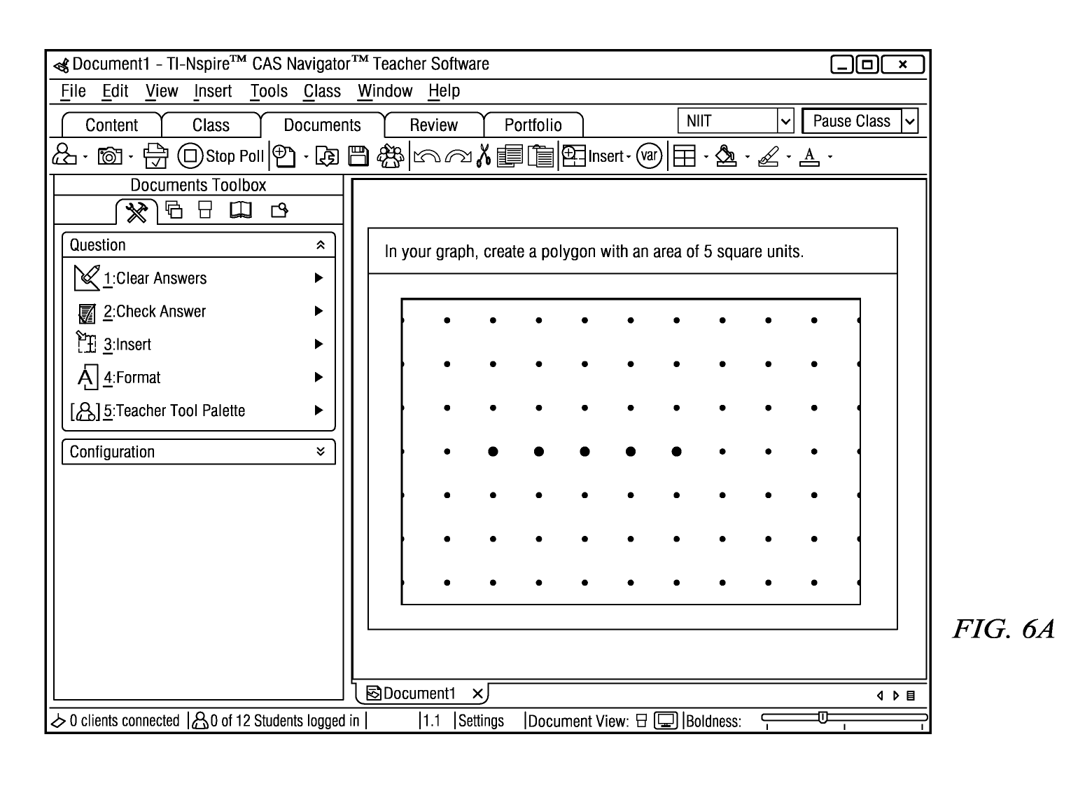

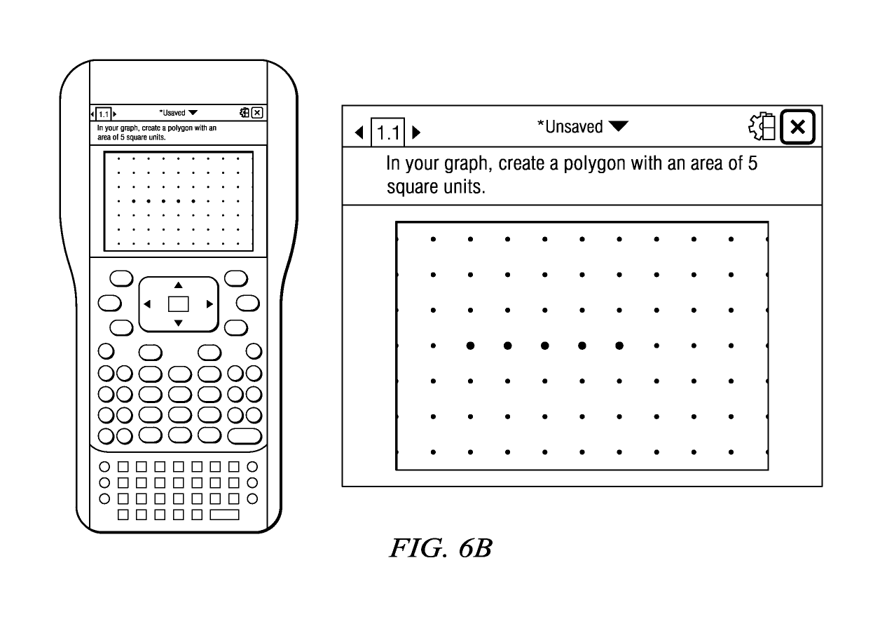

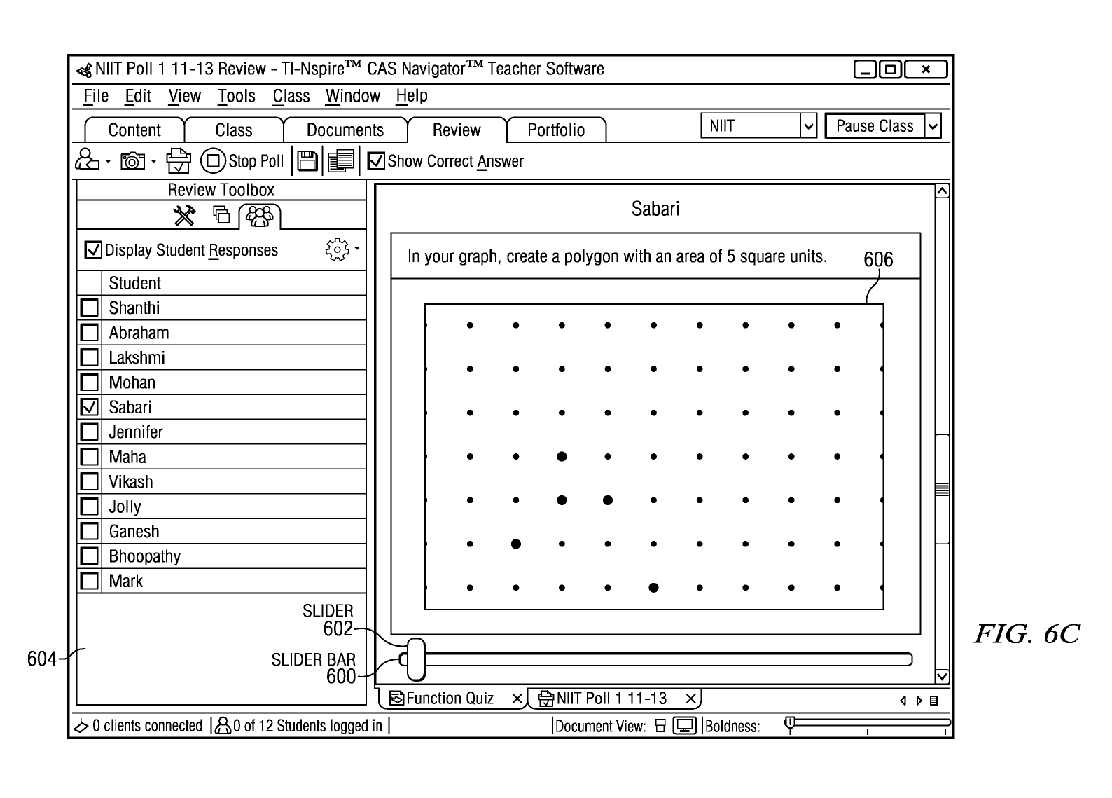

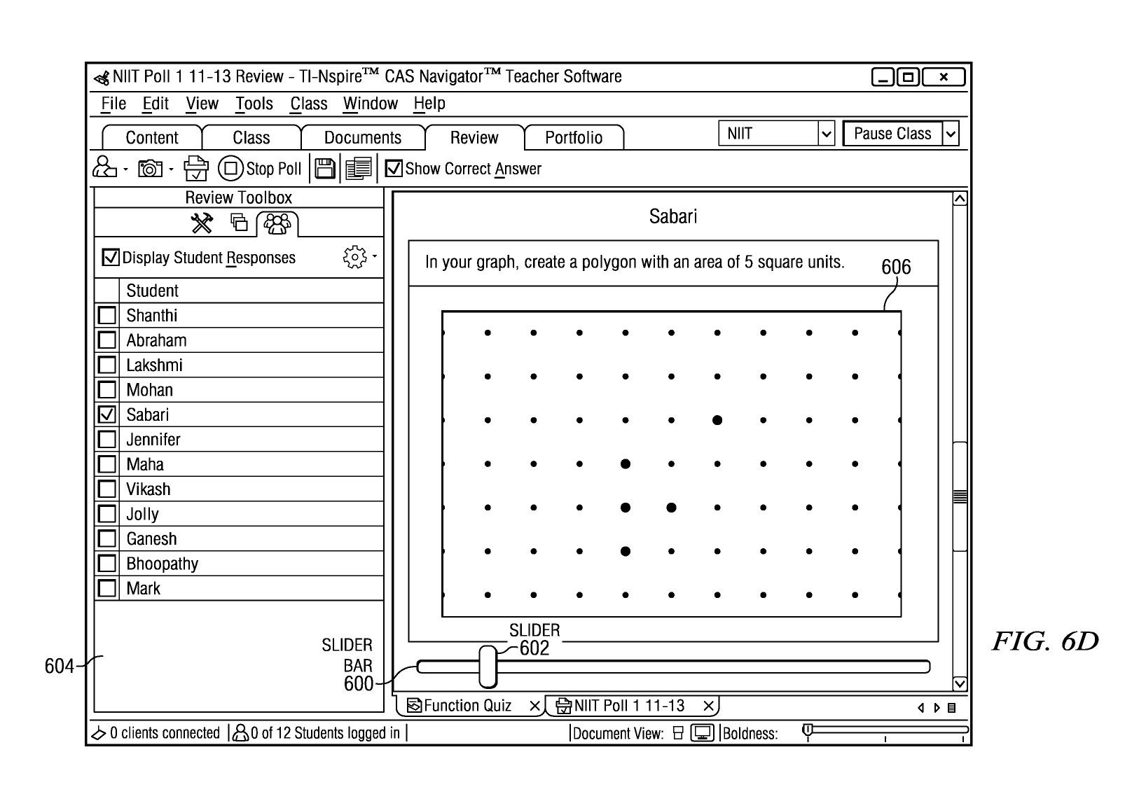

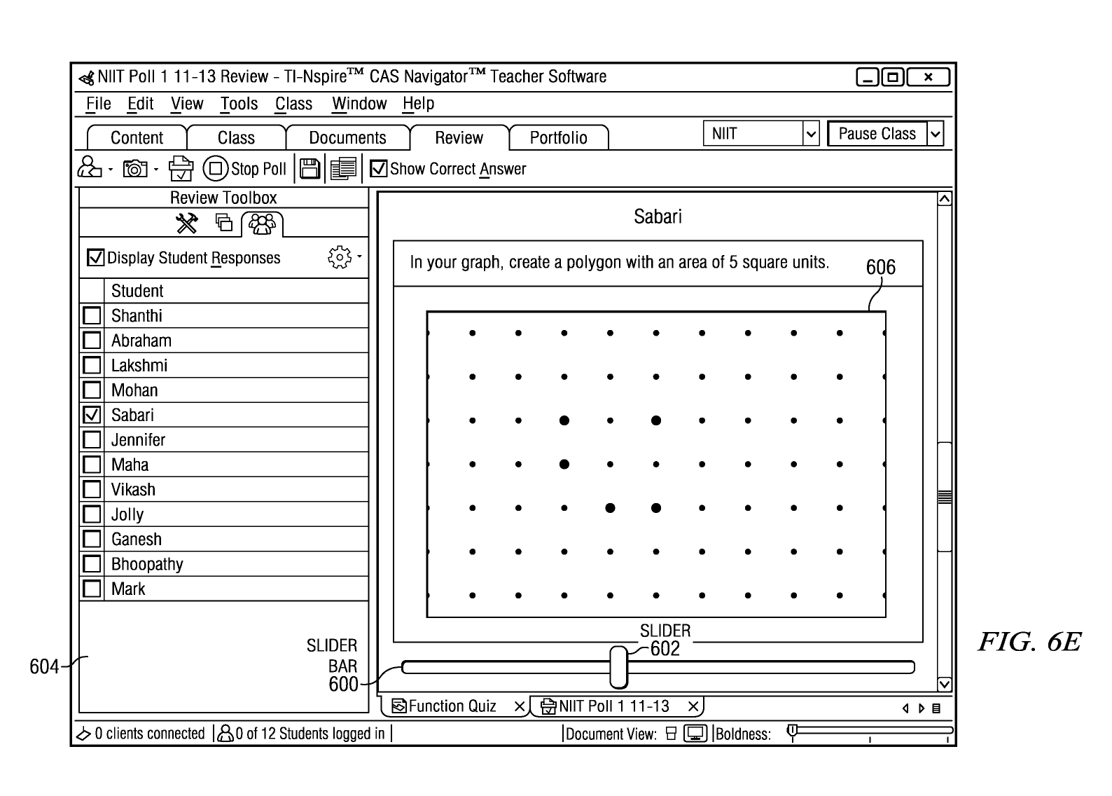

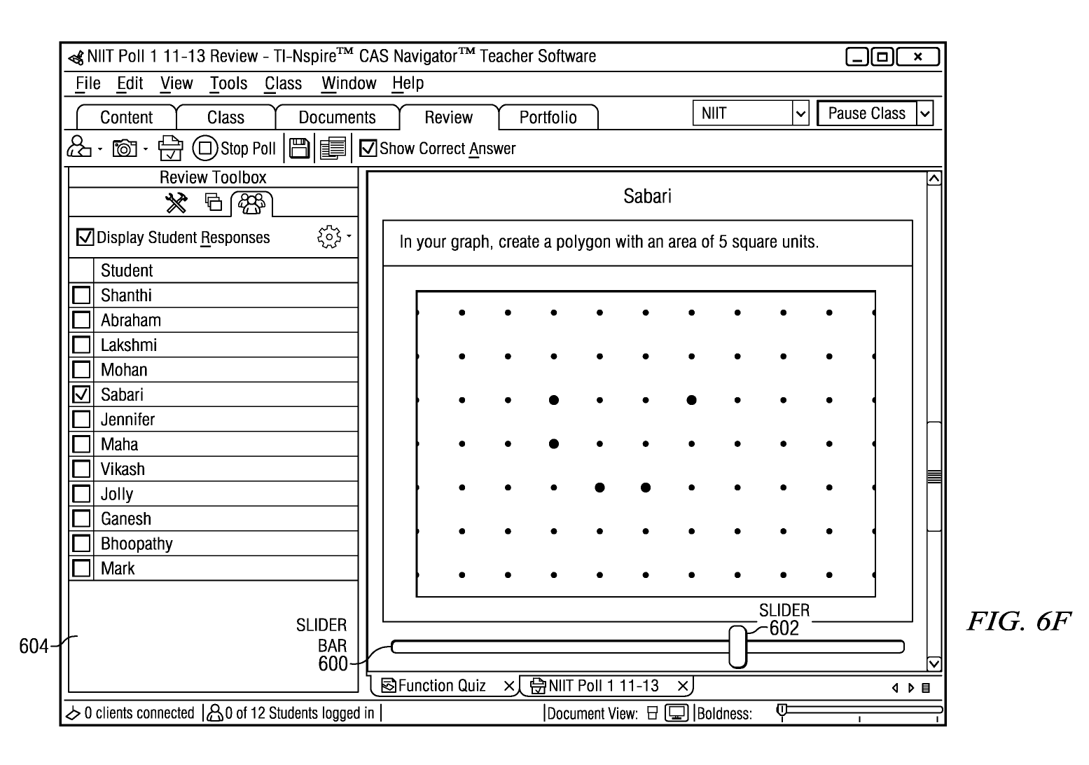

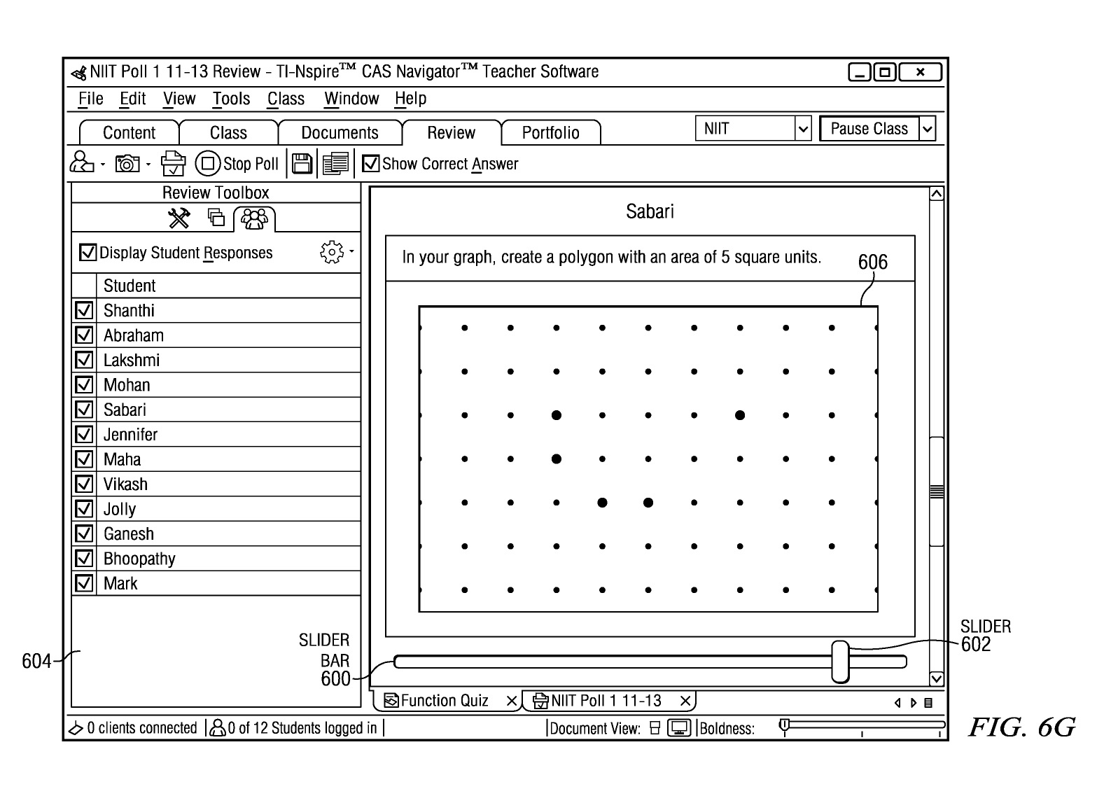

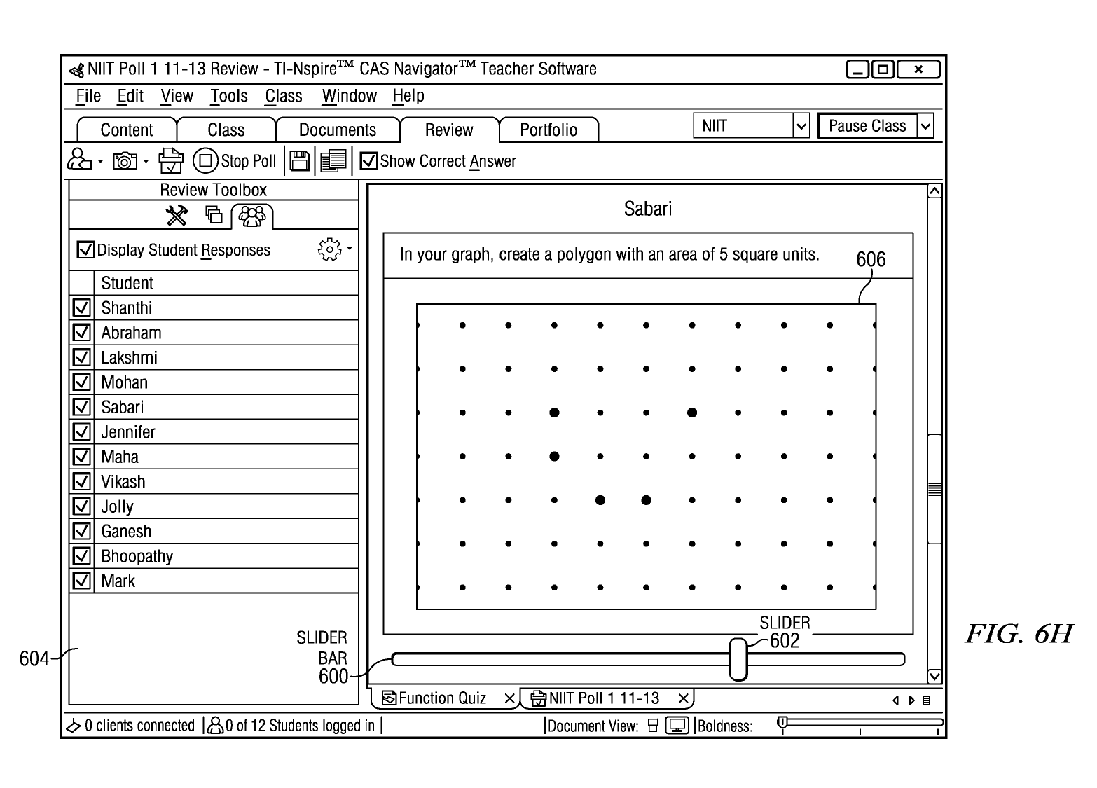

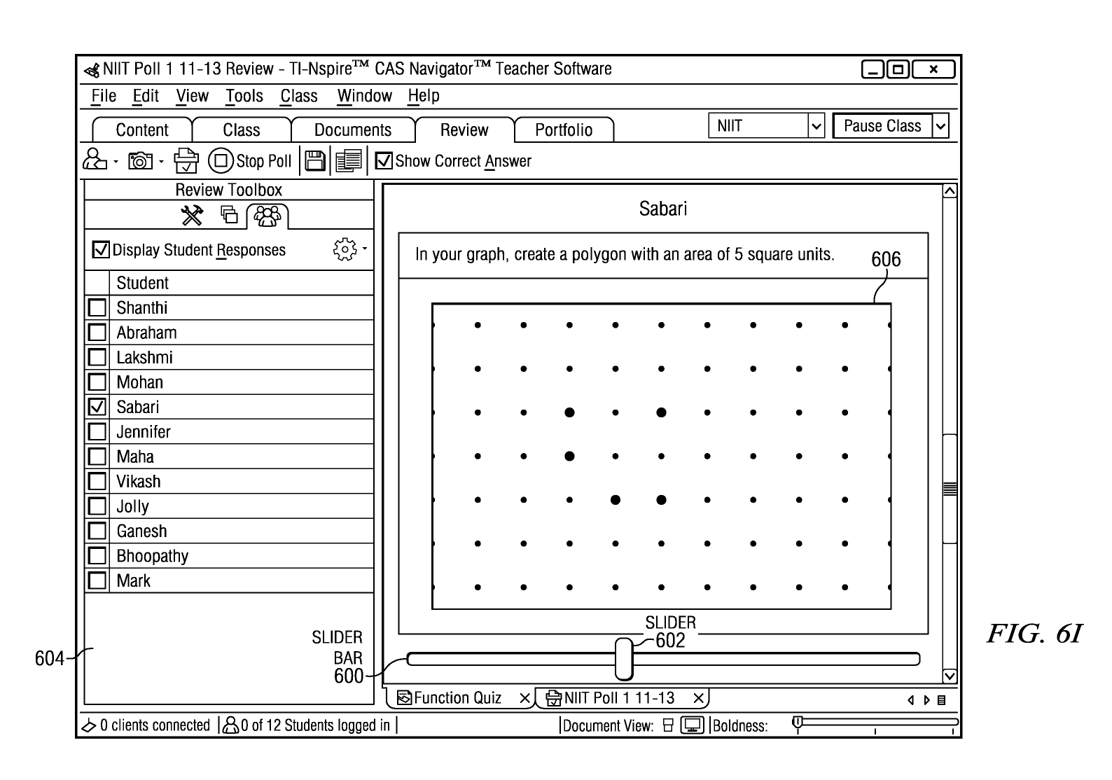

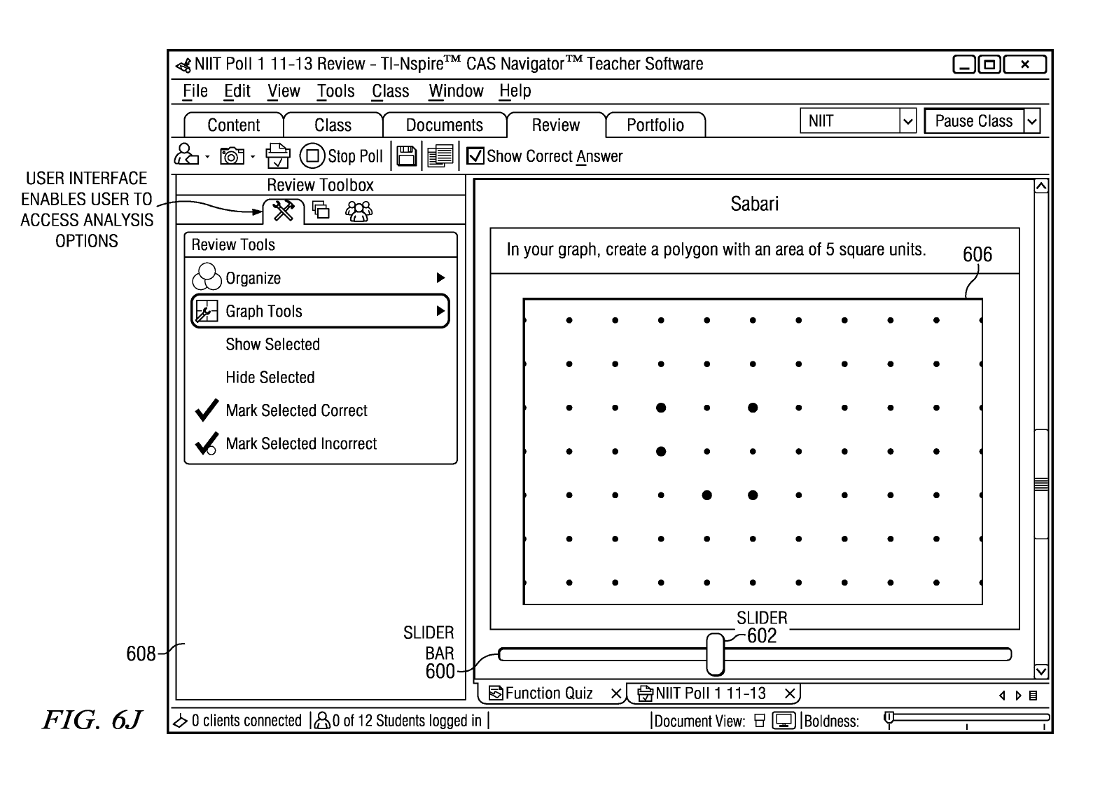

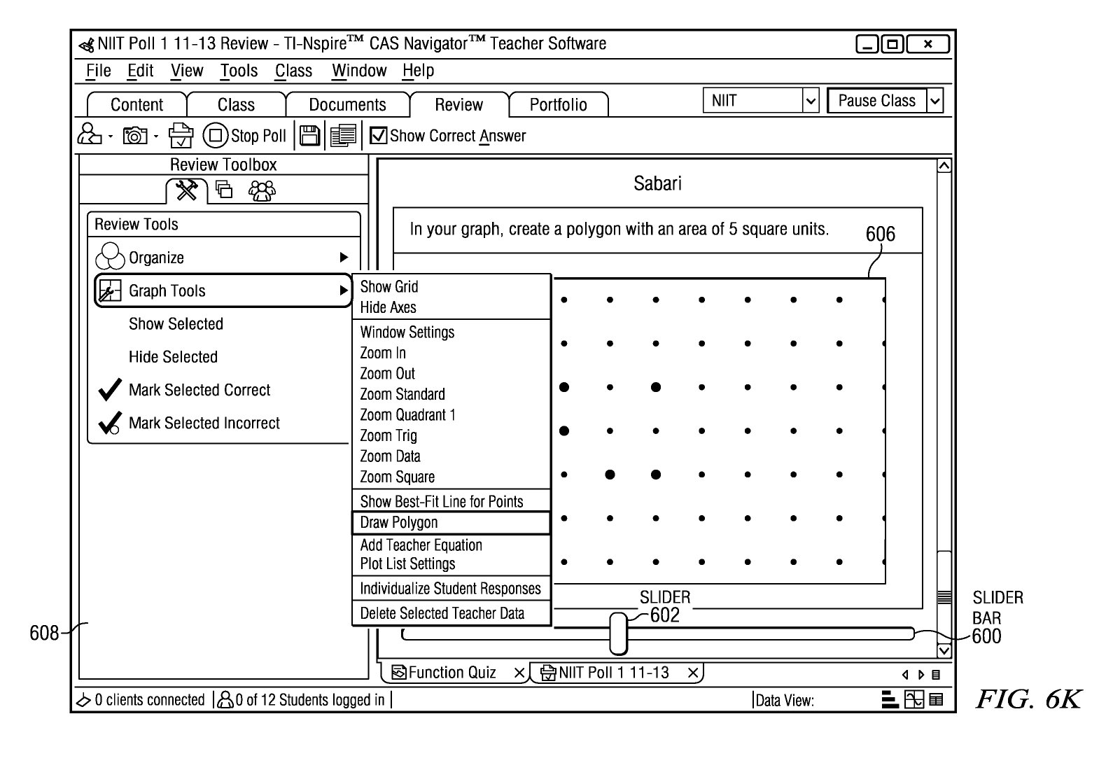

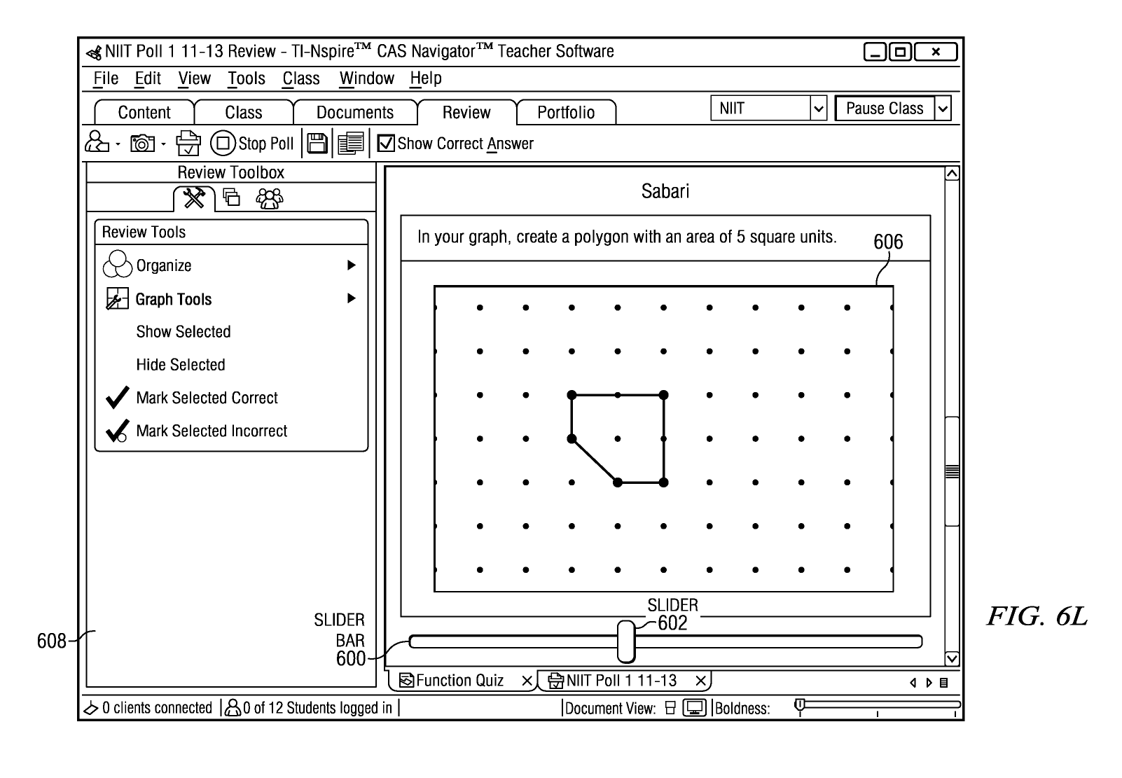

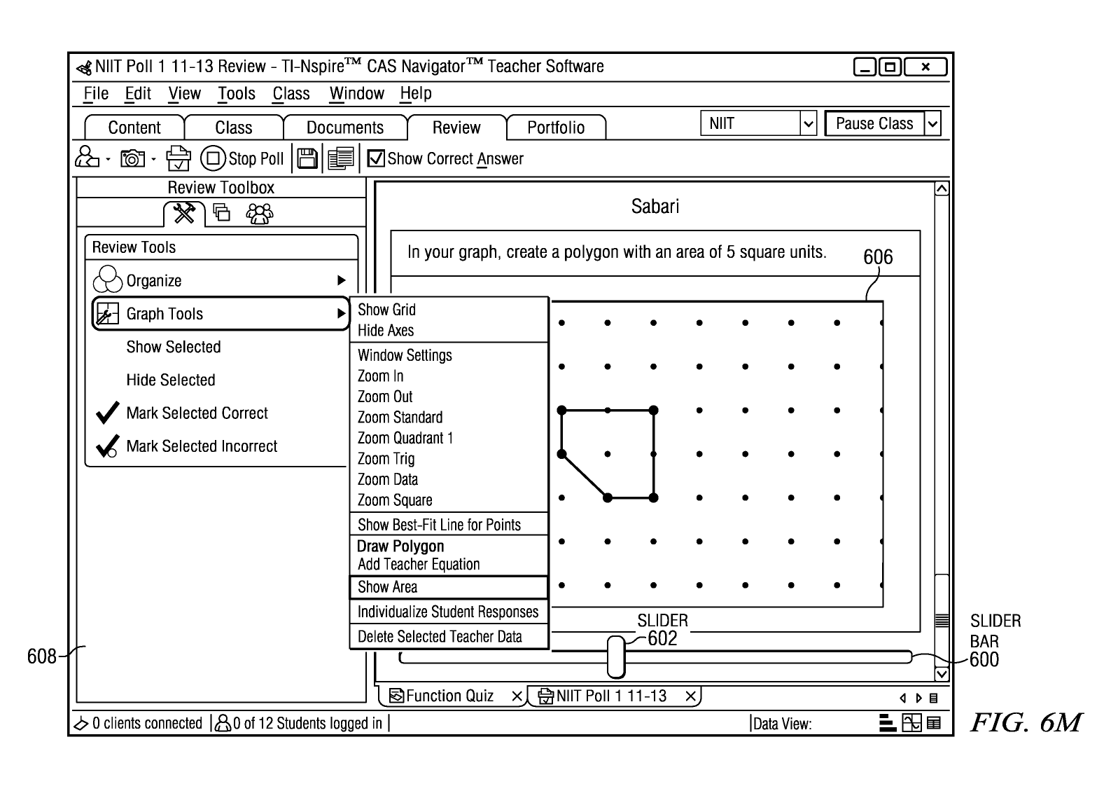

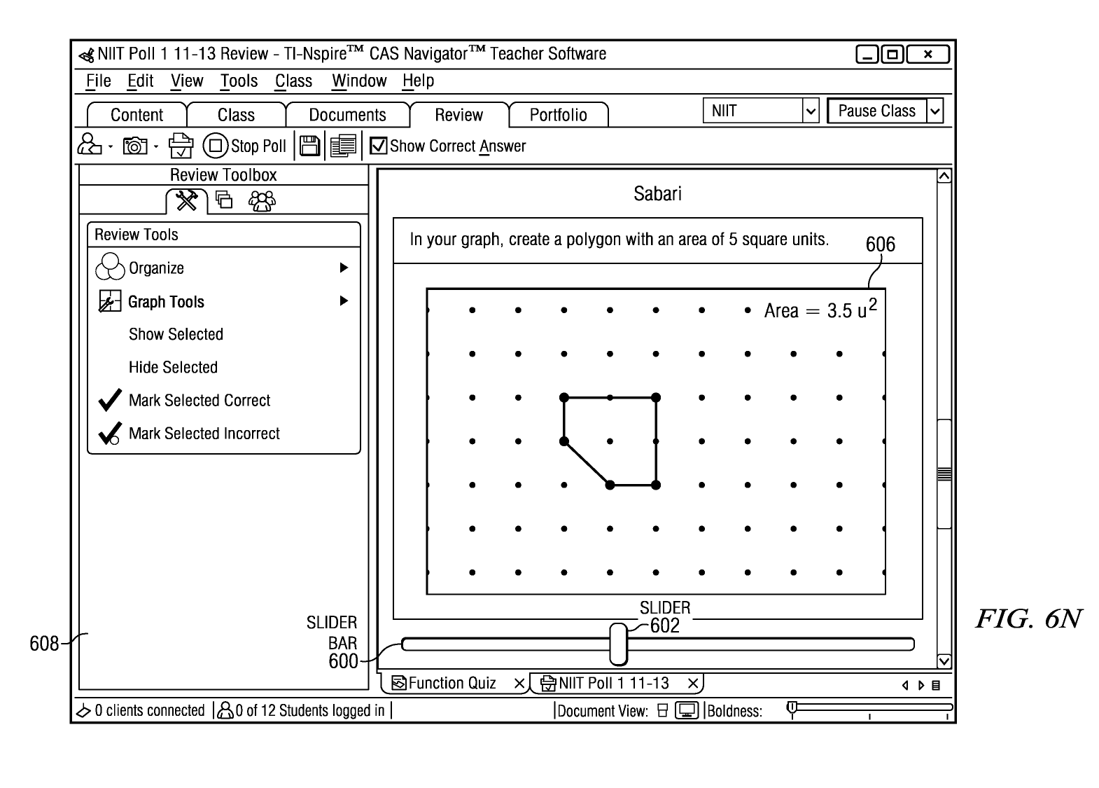

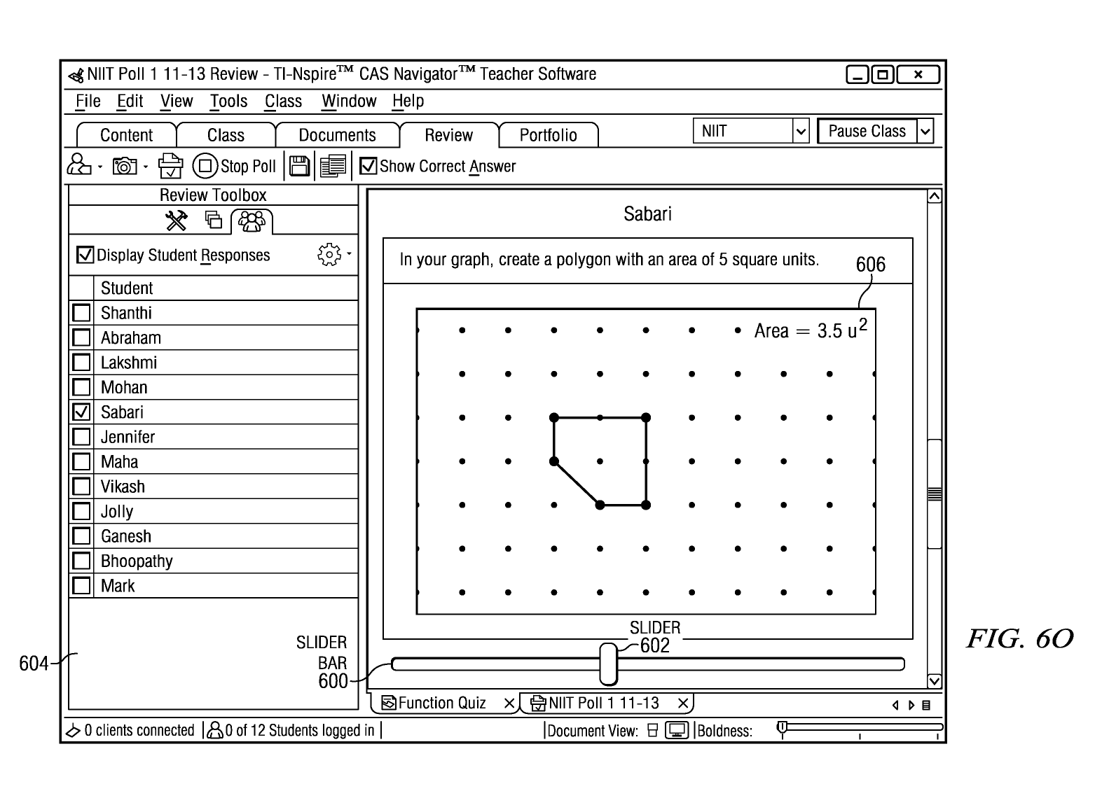

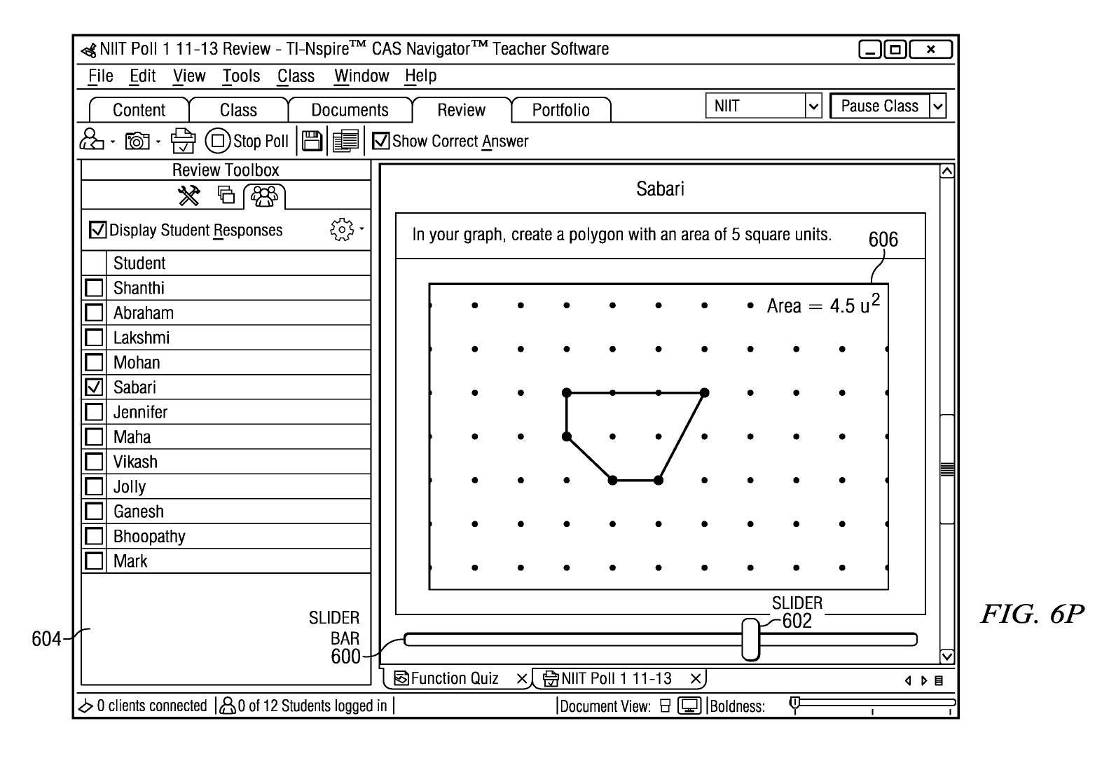

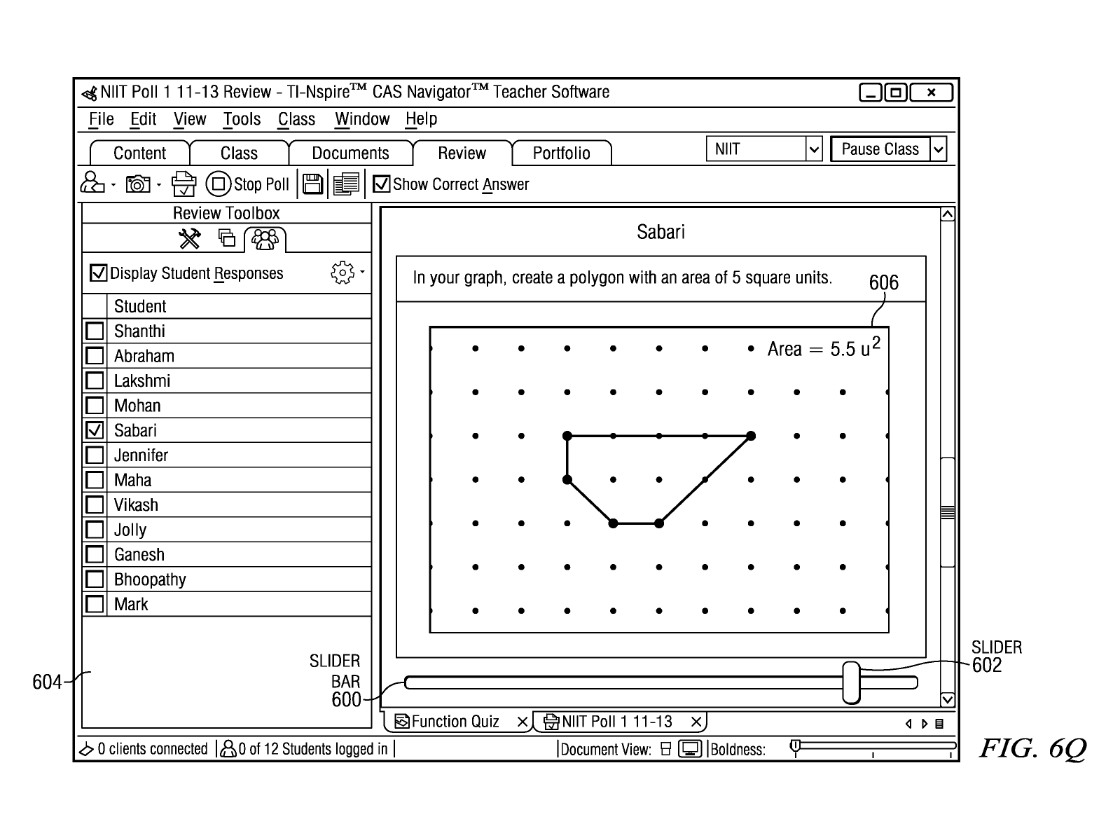

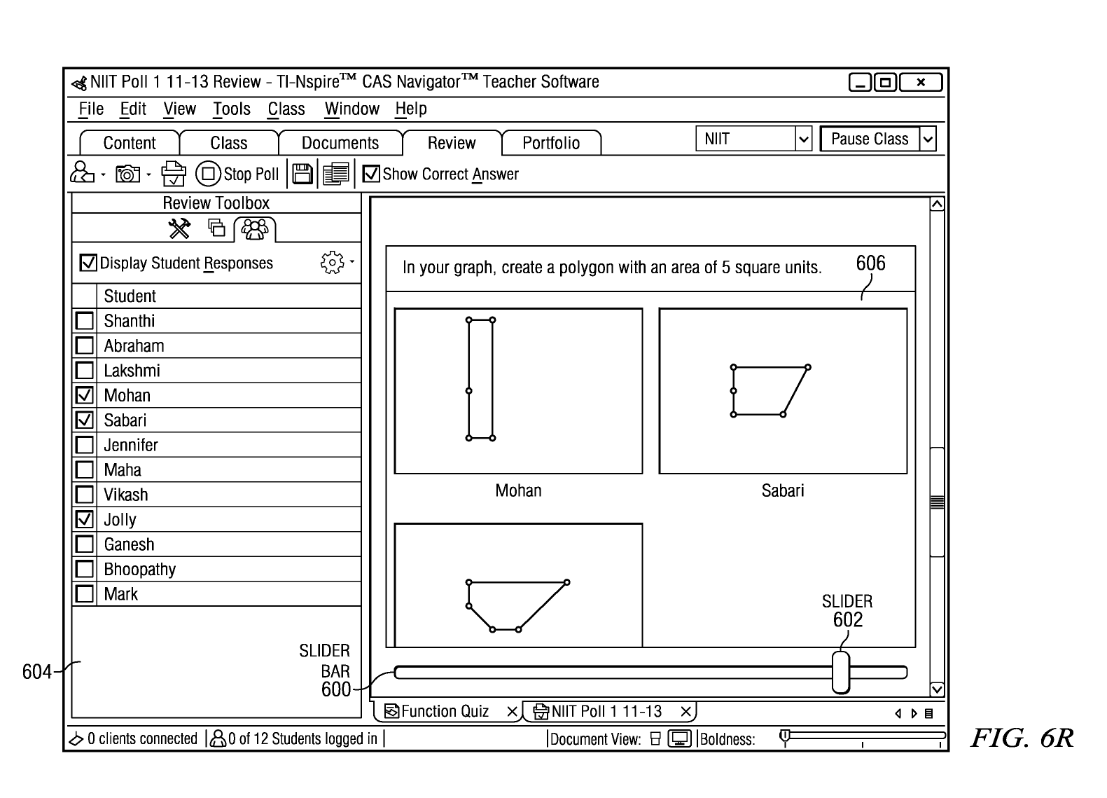

Any suitable user interface for controlling the replay may be used that allows the user to select an arbitrary point in the time period to begin replay, to move back and forth in the time period, and to stop and start the replay. In one embodiment, the interface may provide controls similar to those used to controls replay of recorded video. In one embodiment, a slider bar control is used that allows the user to click and move a slider back and forth across a bar to select a point to begin replay and to click on the slider to stop and start replay. This interface is illustrated in the example of FIGS. 6A-6R.

In some embodiments, each time a student changes a response, the new response is recorded along with a timestamp. The new response represents a complete response, not just part. Thus, any prior data is superseded by the new data. Accordingly, if a teacher starts a replay at any arbitrary point in time, the replay can begin with the response(s) having a timestamp(s) immediately at or immediately preceding the selected point in time. Any prior data does not need to be loaded or replayed to establish state as each piece of time stamped data represents a complete response.

In some embodiments, the data stored for a student response may not be a complete response, but a delta from the previously stored data. Accordingly, if a teacher starts a replay at some point in time, the system would need to replay some or all of the prior time-stamped data in the background to generate a complete response at the specified point in time. This is similar to a digital video file with a key frames interspersed with delta frames. A key frame is a complete snapshot of a frame and can be directly displayed. Delta frames contain the differences from the prior delta or key frame. If a selected time point in the video file is on a delta frame, the player has to find the closest key frame prior to the requested time and replay the key frame and the delta frames leading up to the selected time point. This same technique may be applied for storing student responses, i.e., periodic (key) snapshots of data interspersed with (delta) minor changes, all of which are time stamped.

FIGS. 6A-6R show an example of student response replay. In this example, each student is asked to create a polygon with an area of 5 square units using 5 points. The teacher initiates a class activity that is transmitted to the student calculators. The initial view of this class activity on the host computer is shown in FIG. 6A. The initial view of the class activity on a calculator is shown in FIG. 6B. The teacher sets up polling on the host computer and each student performs the activity on his or her calculator. As each student performs the activity, each calculator polled and the state of each problem solution on the calculator is transmitted to the host computer. The teacher can watch the activity in real time or after the activity is stopped, the teacher can replay the activity for each calculator.

FIG. 6C shows an example replay screen. The screen includes a class roster pane 604 listing the students performing the activity and a review pane 606 showing the activity of one or more students selected in the class roster pane 604. In this screen, a single student, Sabari, is selected. A slider control at the bottom of the review pane 606 includes a slider bar 600 representing time and a slider 602. The teacher may move the slider 602 back and forth across the slider bar 600 to move backward and forward in time in the activity. The review pane 606 in FIGS. 6C-6I illustrate replay of Sabari's performance of the activity. The relative positions of the slider 602 on the slider bar 600 and the dots in the review pane 606 show that the teacher is moving backward and forward in the recorded activity data. Specifically, the teacher is moving the timeline forward from FIG. 6E to FIG. 6G and then backward from FIG. 6G to FIG. 61.

The teacher may be replaying Sabari's data to illustrate various points regarding how Sabari approached the solution to the activity. For example, Sabari may have settled on a strategy of moving a single point and trying to find a pattern such as the area increasing by 1 square unit for each unit movement to the right. Note that in FIGS. 6E-6I only a single point is moving. Even if Sabari did not see the pattern, the teacher can point it out to the class during the replay using various drawing/calculation tools to make it more apparent. For example, the teacher may want to overlay a polygon on the points in the review pane 606 so that the students can more clearly see the change in the polygon shape as the point is moved.

As shown in FIG. 6J, to select the polygon overlay, the teacher clicks on an icon in the user interface that causes the student roster pane to be replaced by a review tools pane 608. The teacher then selects the “graph tools” option. As shown in FIG. 6K, a menu is popped up and the teacher selects the “draw polygon” option. As shown in FIG. 6L, a polygon is then drawn (overlaid) over the 5 points in the review pane 606. As shown in FIG. 6M and FIG. 6N, the teacher also uses the menu to cause the area of the polygon to be shown in the review pane 606.

As shown in FIGS. 6O-6Q, the teacher may then use the slider 602 to move back and forth in the replaying data, more clearly illustrating the effect of the movement of the single point. The teacher may also choose to replay the performance of the activity by more than one student simultaneously. As shown in FIG. 6R, the teacher selects the students from the class roster pane 604 and the review pane 606 displays the replayed data for each student in a separate area. Movement of the slider 602 forward or backward will cause the data replay for all the selected students to be move forward or backward in time. This capability allows the teacher to compare and contrast the solution approaches of multiple students on one screen.

### Other Embodiments

While the invention has been described with respect to a limited number of embodiments, those skilled in the art, having benefit of this disclosure, will appreciate that other embodiments can be devised which do not depart from the scope of the invention as disclosed herein.

For example, embodiments are discussed described in which the digital devices in the classroom network are handheld calculators. It should be noted, however, that other types of digital devices, e.g., laptop computers, desktop computers, tablet computers, and handheld computing devices may be used. Examples of other types of handheld computing devices include scientific calculators, advanced calculators able to upload and run software applications, handheld-sized limited-purpose computer devices, handheld-sized educational computer devices, handheld-sized portable computer devices, portable computer devices, personal digital assistants (PDA), palmtop computers, cellular or mobile telephones, and any combination thereof.

In another example, time stamps may be associated with student responses in each calculator and transmitted to the host computer rather than the host computer associating time stamps as student responses are received.

In another example, data collection techniques other than polling may be used to transfer the student responses to the host computer. For example, a protocol may be used in which the calculators broadcast responses as the responses are entered by the students.

In another example, an interactive white board may be used as an input device for the host computer in the classroom network.

It is therefore contemplated that the appended claims will cover any such modifications of the embodiments as fall within the true scope of the invention.

What is claimed is:

1. A method for operating a classroom network comprising a host computer and a plurality of digital devices communicatively coupled to the host computer, the method comprising:
receiving student responses by the host computer from the plurality of digital devices over a period of time, wherein the student responses are generated while performing a class activity on each digital device;
storing the student responses as the student responses are received; and
replaying a user selected portion of the stored student responses on the host computer, wherein the replayed student responses are displayed according to a first user specified analysis view.

2. The method of claim 1, further comprising:
transmitting the class activity from the host computer to the plurality of digital devices.

3. The method of claim 1, further comprising:
displaying the student responses according a user specified analysis view as the student responses are received.

4. The method of claim 1, wherein replaying the portion of the stored student responses further comprises replaying the portion of the stored student responses beginning at a point in the period of time designated by the user.

5. The method of claim 3, wherein the point in the period of time is designated by the user using an interface control configured to allow the user to select the point relative to the period of time.

6. The method of claim 1, further comprising:
changing the first user specified analysis view responsive to user input as the portion of the stored student responses is replayed.

7. The method of claim 1, wherein the replayed student responses are displayed according to the first user specified analysis view and a second user specified analysis view, wherein the first user specified analysis view and the second user specified analysis view are displayed simultaneously.

8. The method of claim 1, wherein storing the student responses comprises storing a time stamp in association with each student response, wherein a time stamp indicates when an associated student response was received.

9. The method of claim 1, wherein at least one of the plurality of digital devices is a handheld calculator.

10. A classroom network comprising:
a plurality of digital devices; and
a host computer communicatively coupled to the plurality of digital devices and configured to:
receive student responses from the plurality of digital devices over a period of time, wherein the student responses are generated while performing a class activity on each digital device;
store the student responses as the student responses are received; and
replay a user selected portion of the stored student responses, wherein the replayed student responses are displayed according to a first user specified analysis view.

11. The classroom network of claim 10, wherein the host computer is further configured to:
transmit the class activity to the plurality of digital devices.

12. The classroom network of claim 10, wherein the host computer is further configured to:
display the student responses according a user specified analysis view as the student responses are received.

13. The classroom network of claim 10, wherein the host computer is further configured to replay the portion of the stored student responses beginning at a point in the period of time designated by the user.

14. The classroom network of claim 13, wherein the point in the period of time is designated by the user using an interface control configured to allow the user to select the point relative to the period of time.

15. The classroom network of claim 10, wherein the host computer is further configured to:
change the first user specified analysis view responsive to user input as the portion of the stored student responses is replayed.

16. The classroom network of claim 10, wherein the replayed student responses are displayed according to the first user specified analysis view and a second user specified analysis view, wherein the first user specified analysis view and the second user specified analysis view are displayed simultaneously.

17. The classroom network of claim 10, wherein the host computer is further configured to store a time stamp in association with each student response, wherein a time stamp indicates when an associated student response was received.

18. The classroom network of claim 10, wherein at least one of the plurality of digital devices is a handheld calculator.
